(19) United States
(12) Patent Application Publication
(10) Pub. No.: US 2026/0282180 A1
(43) Pub. Date: Sep. 17, 2026

(54) DEVICE

(71) Applicant: SHARP KABUSHIKI KAISHA, Sakai City, Osaka (JP)

(72) Inventor: YUKISHIGE SHIRAICHI, Sakai City, Osaka (JP)

(21) Appl. No.: 19/125,506

(22) PCT Filed: Nov. 6, 2023
(86) PCT No.: PCT/JP2023/039786

§ 371 Date: Apr. 29, 2025

(30) Foreign Application Priority Data
Nov. 9, 2022 (JP) 2022-179178

(51) Int. Cl. H05B 6/72; H05B 6/64; H05B 6/66

(52) U.S. Cl. CPC H05B 6/72; H05B 6/642; H05B 6/66

(57) ABSTRACT

The purpose of the present disclosure is to provide a device capable of efficiently performing cooling of an antenna.

The device of the present disclosure is characterized by comprising a housing, a first container provided inside the housing and capable of maintaining a depressurized state, a second container provided inside the first container to house an item to be processed, an antenna space portion provided inside the second container and composed of a member a part of which transmits a microwave, an antenna provided inside the antenna space portion to emit a microwave, and an opening portion provided in the antenna space portion, wherein the antenna is connected to a high-frequency oscillation circuit via a transmission line, and the opening portion is a hole penetrating through the first container and the second container to provide communication between the housing and the antenna space portion.

### TECHNICAL FIELD

The present disclosure relates to a device. The present application claims priority to Japanese Patent Application No. 2022-179178 filed in Japan on Nov. 9, 2022, the contents of which are incorporated herein by reference.

### BACKGROUND ART

Conventionally, a device that heats an item to be processed with microwaves has been disclosed.

For example, in a device (vacuum dryer) in Patent Literature 1, a vacuum container 3 is provided in a dielectric heating device 1, and a pipe 33 connected to a vacuum pump passes through a hole 12 and is connected to the vacuum container 3. An object to be processed is housed in the vacuum container and subjected to drying treatment by decompression and dielectric heating with microwaves.

Further, in a device (decompression high-frequency heating device) in Patent Literature 2, a sealed container 3 serves as both a vacuum container and a microwave shielding container, and a waveguide 7 connected to a magnetron 6 is connected to the sealed container, and an exhaust pipe 10a connected to a vacuum pump 12 is connected to the sealed container. An object 2 to be heated is housed in the sealed container 3, and is treated by decompression and dielectric heating with microwaves.

The devices according to Patent Literatures 1 and 2 are configured such that the vacuum container is housed in the microwave shielding container or one sealed container serves as both the vacuum container and the microwave shielding container.

### CITATION LIST

### Patent Literatures

Patent Literature 1: JP 2003-262465 A

Patent Literature 2: JP H07-318067 A

### SUMMARY

### Technical Problem

In the above device, an output antenna that emits microwaves is cooled by air cooling, but, in particular, in a case where the antenna is provided inside the vacuum container, if the structure is that a surrounding space of the antenna unit is depressurized, it is difficult to dissipate heat via antenna surrounding gas, and for this reason, cooling of the antenna may be insufficient, and efficiency of microwave supply may be lowered.

Therefore, in view of the above problem, an object of the present disclosure is to provide a device capable of efficiently cooling an antenna.

### Solution to Problem

A device according to the present disclosure includes a housing, a first container that is provided in the housing and capable of maintaining a depressurized state, a second container that is provided in the first container and houses an item to be processed, an antenna space portion that is provided in the second container, a part of the antenna space portion being formed of a member that transmits a microwave, an antenna that is provided in the antenna space portion and emits a microwave, and an opening portion provided in the antenna space portion, in which the antenna is connected to a high frequency oscillation circuit via a transmission line, and the opening portion is a hole that penetrates the first container and the second container and allows the housing and the antenna space portion to communicate with each other.

### Advantageous Effects of Disclosure

As described above, according to the present disclosure, it is possible to provide a device capable of efficiently cooling an antenna.

### BRIEF DESCRIPTION OF DRAWINGS

FIG. 1 is a side view schematically illustrating a device according to a present embodiment.

FIG. 2 is an enlarged side view of a portion of II in FIG. 1.

FIG. 3 is a side view schematically illustrating a device according to another embodiment.

FIG. 4 is a side view schematically illustrating a device showing a variation according to the present embodiment.

### DESCRIPTION OF EMBODIMENTS

Hereinafter, a preferred embodiment of the present disclosure will be described in detail with reference to the drawings. Note that the present embodiment described below does not unreasonably limit the content of the present disclosure described in the claims, and all the configurations described in the present embodiments are not necessarily essential as solutions of the present disclosure. Note that, in the drawings, in order to facilitate description of a positional relationship of each configuration, description will be made using the terms upper, lower, front, and rear.

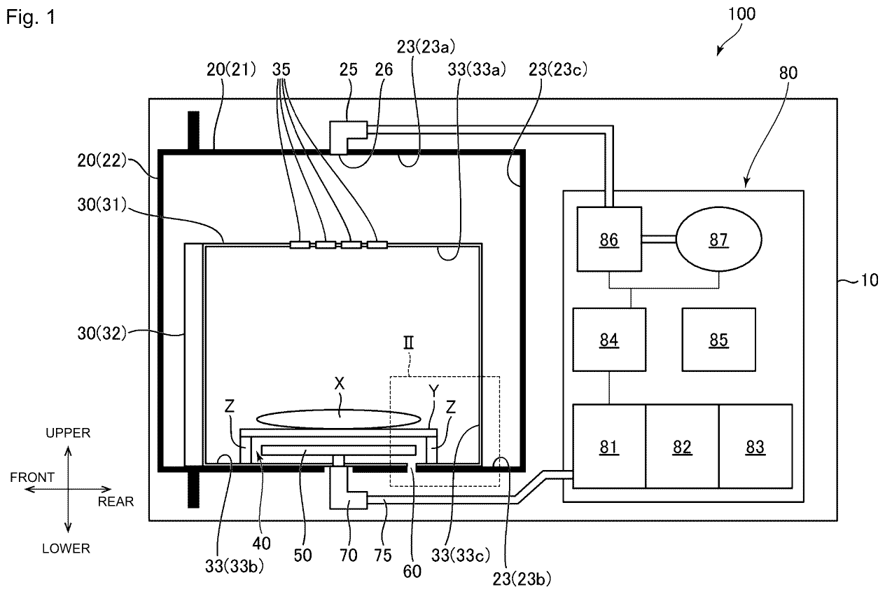

FIG. 1 is a side view schematically illustrating a device 100 according to a present embodiment. As illustrated in FIG. 1, the device 100 according to the present embodiment includes a housing 10, a first container 20, and a second container 30. Examples of the device 100 according to the present embodiment, a device 200 according to another embodiment to be described later, and a device 300 showing a variation according to the present embodiment include a vacuum dryer, a microwave heating device, a defroster, a microwave heating device with enhanced defrosting quality, a vacuum cooker, and the like.

In the housing 10, the first container 20, the second container 30, an antenna space portion 40, an antenna 50, and an opening portion 60 are provided. Further, an accessory 80 for operating the device 100 is provided in the housing 10.

The accessory 80 includes a high frequency oscillation circuit 81, a heat sink 82, a cooling fan 83 of the accessory 80, a control circuit 84, a power supply 85, a cold trap 86, a vacuum pump 87, and the like.

The first container 20 is a sealed container that is provided in the housing 10 and can maintain a depressurized state, and is, for example, a vacuum container.

Further, the first container 20 includes a main body portion 21 of the first container 20 and a lid portion 22 of the first container 20. The lid portion 22 of the first container 20 can be opened and closed, and the lid portion 22 of the first container 20 allows content of the first container 20 to be taken out.

Further, the first container 20 and the accessory 80 are connected by a connection pipe 25, and the inside of the first container 20 is depressurized through the connection pipe 25 provided in an exhaust port 26 of the first container.

The second container 30 is provided in the first container 20, shields microwaves, and houses an item X to be processed. The second container 30 is a sealed container capable of maintaining a depressurized state. Examples of the second container 30 include a microwave shielding container and the like. Note that the item X to be processed may be placed on a table Y. The second container 30 includes a main body portion 31 of the second container 30 and a door portion 32 of the second container 30. The door portion 32 of the second container 30 can be opened and closed, and the door portion 32 of the second container 30 allows content such as the item X to be processed of the second container 30, the antenna space portion 40 to be described later, and the antenna 50 to be taken out. Further, the second container 30 has an opening hole 35.

The opening hole 35 allows gas in the second container 30 to flow to the first container 20. Further, the opening hole 35 shields microwaves. A plurality of the opening holes 35 are formed by small punched holes or the like so as not to leak microwaves. As the vacuum pump 87 operates, gas in the second container 30 is discharged from the opening hole 35 to the outside of the second container 30. Further, the opening hole 35 may be provided in a plurality of walls 33 of the second container 30, for example, an upper wall 33a of the second container 30 as illustrated in FIG. 1. Furthermore, the opening hole 35 may be provided in the vicinity of the item X to be processed and the exhaust port 26 of the first container 20. Further, the opening hole 35 can also be provided in a rear wall 33c of the second container 30. Note that the exhaust port 26 of the first container 20 is provided in an upper wall 23a of the first container 20.

Emission of microwaves accompanying operation of the high frequency oscillation circuit 81 is performed in the second container 30 and the antenna space portion 40 described later, and microwaves do not leak into a space between the first container 20 and the second container 30. The item X to be processed placed in the second container 30 is treated by depressurization and dielectric heating with microwaves.

The antenna space portion 40 is provided in the second container 30. The antenna space portion 40 is a space for accommodating the antenna 50, and includes the table Y on which the item X to be processed is placed, a leg Z supporting the table Y, and the like. The antenna space portion 40 is not depressurized and is under atmospheric pressure.

The antenna space portion 40 is partially formed of a member that transmits microwaves. In the antenna space portion 40, at least an upper portion of the antenna 50 is a member that transmits microwaves, and the table Y on which the item X to be processed is placed is formed of a member that transmits microwaves. A member that transmits microwaves is, for example, a member made of a dielectric having a small loss coefficient. Examples of the dielectric having a small loss coefficient include ceramic glass and Teflon (registered trademark).

Further, the antenna space portion 40 is provided on the lower side of the second container 30. The antenna space portion 40 is provided on the upper side of a lower wall 33b of the second container 30 while being in contact with a lower wall 23b of the first container 20 and the lower wall 33b of the second container 30.

The antenna 50 is a member that emits microwaves, and is provided in the antenna space portion 40. Further, the antenna 50 is connected to the high frequency oscillation circuit 81 of the accessory 80 via a connection member 70 and a transmission line such as a cable 75. Examples of the cable 75 include a coaxial cable.

The antenna 50 emits microwaves. The antenna 50 may be a magnetron including a vacuum tube as a microwave source. Microwaves output from the magnetron are emitted into the second container 30 that is metal-shielded. Further, as illustrated in FIG. 1, in a case where the antenna 50 is provided on the lower side of second container 30, the antenna 50 emits microwaves from the lower side to the upper side.

As the microwave source, a gallium nitride (GaN) semiconductor is preferably used. In this way, a patch antenna used in a wireless device can be used for the item X to be processed in the second container 30. Furthermore, by employing a system in which the antenna 50 (patch antenna) and the item X to be processed are combined at one wavelength or less, energy of microwaves can be efficiently transmitted to a heating portion, and the device can also be downsized. Moreover, since a microwave source made from a gallium nitride (GaN) semiconductor is smaller than a magnetron, a plurality of the microwave sources can be attached to one device. Selective heating in which only a specific microwave source emits microwaves, uniform heating in which all sources simultaneously emit microwaves, and the like can be performed.

The opening portion 60 is provided in the antenna space portion 40. Further, the opening portion 60 is a hole that penetrates the first container 20 and the second container 30 and allows the housing 10 and the antenna space portion 40 to communicate with each other.

If the antenna 50 has a structure in which heat is generated to emit microwaves and a surrounding space of the antenna 50 is depressurized, it is difficult to dissipate heat via surrounding gas of the antenna 50, and for this reason, cooling of the antenna 50 may be insufficient and efficiency of microwave supply may be reduced.

In view of the above, heat is dissipated via surrounding gas of the antenna 50 and gas inside the housing 10 outside the antenna space portion 40 by use of the opening portion 60, and the antenna 50 can be efficiently cooled. Hereinafter, the opening portion 60 will be described in detail below.

As illustrated in FIG. 1, the opening portion 60 is preferably provided at an end of the antenna space portion 40 away from the antenna 50. For example, the antenna 50 is provided at the center of the antenna space portion 40, and an opening portion is provided at an end of the antenna space portion 40. In this way, cooling efficiency of the antenna 50 is improved.

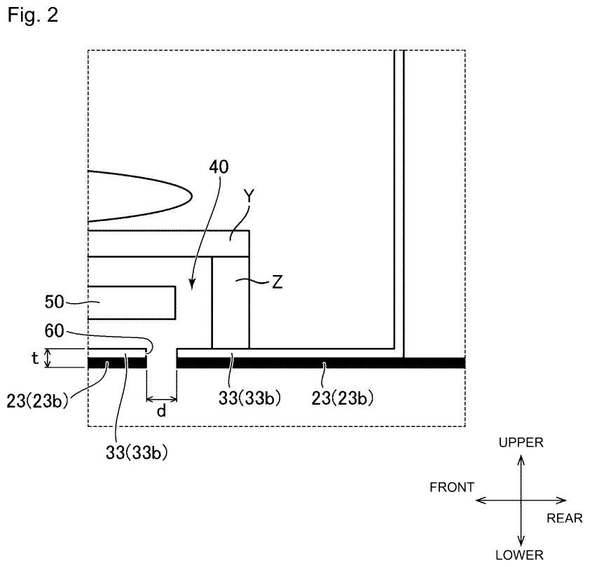

Further, as illustrated in FIG. 2, the opening portion 60 is preferably a hole satisfying d≤32 t/S, where d is a hole diameter (mm), t is an axial length of the hole (mm), and S is an attenuation factor of microwaves (dB). The axial length t of the hole is, for example, thickness of the lower wall 23b of the first container 20 and thickness of the lower wall 33b of the second container 30.

By setting d≤32 t/S, an advantage below can be obtained. Assuming that output of the magnetron is 500 W and the standard for radio wave leakage is 5 mW, the required attenuation amount S is 10·log (500/0.005)=50 dB. For this reason, when a ratio of the hole diameter d to the axial length t of a hole 11 is set to 0.64 (=32/50) or less according to the equation d≤32 t/S, it is possible to satisfy the standard of radio wave leakage for a magnetron 6 having output of 500 W or less. Further, assuming that output of the magnetron 6 is 1000 W and the standard for radio wave leakage is 5 mW, the required attenuation amount S is 10·log (1000/0.005)=53 dB. For this reason, when a ratio of the hole diameter d to the axial length t of a hole of the opening portion 60 is set to 0.60 (=32/53) or less according to the equation d≤32 t/S, it is possible to satisfy the standard of radio wave leakage for the magnetron 6 having output of 1000 W or less. Therefore, the opening portion 60 preferably satisfies the equation d≤32 t/S. Therefore, in this way, it is possible to more efficiently cool the antenna 50.

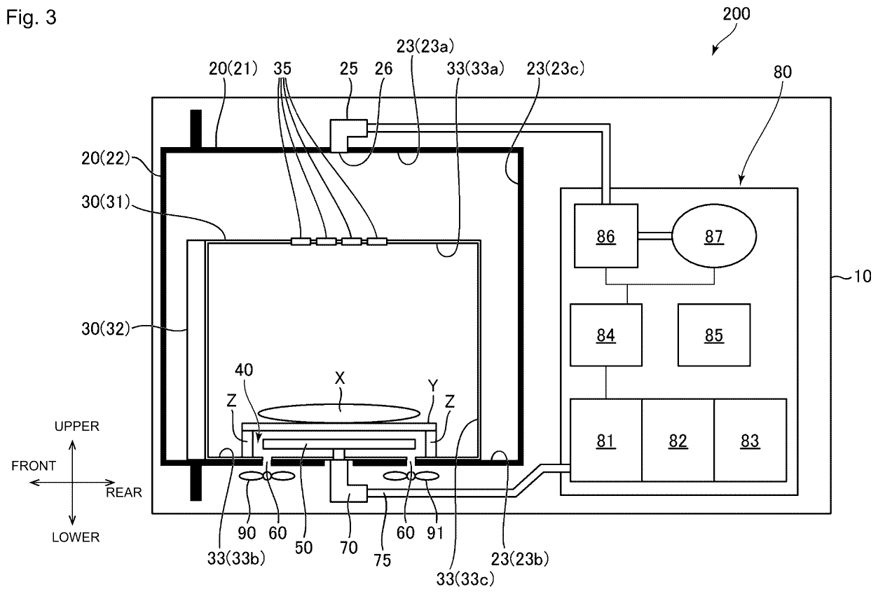

FIG. 3 is a side view schematically illustrating the device 200 according to another embodiment. As illustrated in FIG. 3, a plurality of the opening portions 60 are preferably provided as illustrated in FIG. 3. When a plurality, rather than a single one, of the opening portions 60 are provided, heat dissipation is more efficiently performed via surrounding gas of the antenna 50 and gas in the housing 10 outside the antenna space portion 40, and cooling of the antenna 50 can be more efficiently performed.

A fan 90 that sucks or discharges gas is preferably provided around the opening portion 60. A plurality of the fans 90 are preferably provided, and for example, one of the fans 90 may be provided as a suction fan that sucks gas into the antenna space portion 40, and another fan 91 may be provided as a discharge fan that discharges gas having heat from the antenna space portion 40. In this case, a plurality of the opening portions 60 are provided. In this way, the antenna 50 can be cooled more efficiently.

The opening portion 60 is preferably configured such that the lower wall 23b which is a bottom surface of the first container 20 and the lower wall 33b which is a bottom surface of the second container 30 are in contact with each other, and is preferably formed to penetrate the first container 20 and the second container 30. In this way, since gas in the antenna space portion 40 and gas in the housing 10 are adjacent to each other, heat exchange of the air is efficiently performed, so that the antenna 50 can be cooled more efficiently.

Note that, in the devices 100 and 200 illustrated in FIGS. 1 and 3 and the like, the opening portion 60 is provided in the lower wall 23b of the first container 20 and the lower wall 33b of the second container 30, but the opening portion 60 may be provided in the rear wall 23c of the first container 20 and the rear wall 33c of the second container 30. In such a case, the antenna space portion 40 is provided on the side of the rear wall 23c of the first container 20 and the rear wall 33c of the second container 30. Further, in this case, a direction in which microwaves are emitted is from the rear side to the front side.

As described above, according to the device 100 according to the present embodiment and the device 200 according to another embodiment, it is possible to efficiently cool the antenna 50.

Further, according to the device 100 according to the present embodiment, a high frequency oscillation circuit can be provided outside the first container 20. By the above, internal volume of the second container 30, that is, volume on which an unprocessed item X can be placed can be made larger than volume of the first container 20. Further, it is not necessary to consider influence of a magnetron or an oscillation circuit on a high-frequency transmitter in a vacuum environment.

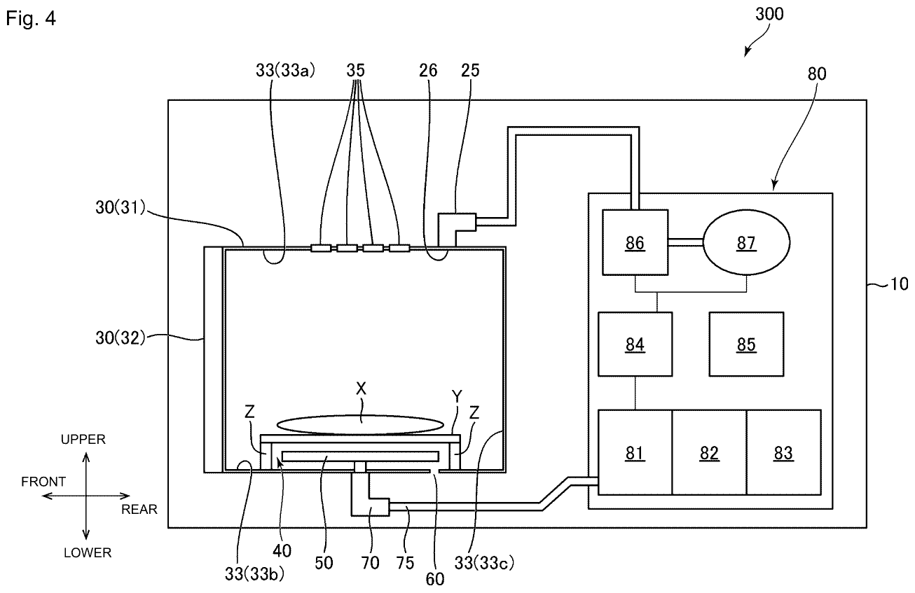

Next, the device 300 showing a variation according to the present embodiment will be described. FIG. 4 is a side view schematically illustrating a device showing a variation according to the present embodiment. As illustrated in FIG. 4, the device 300 showing a variation according to the present embodiment may use only the second container 30 (hereinafter simply referred to as the container 30) without using the first container 20.

That is, device 300 according to a variation of the present embodiment includes the housing 10, the container 30 that shields microwaves, the antenna space portion 40, the antenna 50 that emits microwaves, and the opening portion 60 provided in the antenna space portion 40.

As described above, the device 300 according to another embodiment illustrated in FIG. 4 can also efficiently cool the antenna 50.

As described above, according to the devices 100, 200, and 300 according to the present disclosure, it is possible to efficiently cool the antenna 50.

Note that, although the embodiments and examples of the present disclosure are described in detail as described above, those skilled in the art will easily understand that many modifications can be made without departing from novel matters and effects of the present disclosure. Therefore, all such variations are included in the scope of the present disclosure.

For example, a term described at least once in the description or the drawings together with a different term that is broader in meaning or synonymous can be replaced with the different term anywhere in the description or the drawings. Further, a configuration and operation of the device are not limited to those described in each embodiment and each example of the present disclosure, and various modifications can be made.

1. A device comprising:
a housing;
a first container that is provided in the housing and capable of maintaining a depressurized state;
a second container that is provided in the first container and houses an item to be processed;
an antenna space portion that is provided in the second container, a part of the antenna space portion being formed of a member that transmits a microwave;
an antenna that is provided in the antenna space portion and configured to emit a microwave; and
an opening portion provided in the antenna space portion, wherein
the antenna is connected to a high frequency oscillation circuit via a transmission line, and
the opening portion is a hole that penetrates the first container and the second container and allows the housing and the antenna space portion to communicate with each other.

2. The device according to claim 1, wherein the opening portion is a hole satisfying d≤32 t/S, where d (mm) is a hole diameter, t (mm) is an axial length of a hole, and S (dB) is an attenuation factor of a microwave.

3. The device according to claim 1, wherein the opening portion is provided at an end of the antenna space portion away from the antenna.

4. The device according to claim 1, wherein a plurality of the opening portions are provided.

5. The device according to claim 4, wherein a fan that is configured to suck or discharge gas is provided around the opening portion.

6. The device according to claim 1, wherein the opening portion is formed to penetrate the first container and the second container in a state where a bottom surface of the first container and a bottom surface of the second container are in contact.

7. The device according to claim 1, wherein the second container is a microwave shielding container.

8. A device comprising:
a housing;
a container that is provided in the housing, configured to maintain a depressurized state, and configured to shield a microwave;
an antenna space portion that is provided in the container, a part of the antenna space portion being formed of a member that transmits a microwave;
an antenna that is provided in the antenna space portion and configured to emit a microwave; and
an opening portion provided in the antenna space portion, wherein
the antenna is connected to a high frequency oscillation circuit via a transmission line, and
the opening portion is a hole that penetrates the container and allows the housing and the antenna space portion to communicate with each other.
